(19) United States
(12) Patent Application Publication
(10) Pub. No.: US 2003/0118224 A1
(43) Pub. Date: Jun. 26, 2003

(54) Method of reconstructing a 3D image data set of an examination zone

(76) Inventors: Thomas Koehler, Norderstedt (DE); Michael Grass, Hamburg (DE); Volker Rasche, Hamburg (DE)

Correspondence Address: THOMAS M. LUNDIN, Philips Medical Systems (Cleveland), Inc., 595 Miner Road, Cleveland, OH, 44143, US

(21) Appl. No.: 10/313,102

(22) Filed: Dec. 6, 2002

(30) Foreign Application Priority Data
Dec. 7, 2001 (DE) 10160205.7

(51) Int. Cl. H05G 1/60; G21K 1/12

(52) U.S. Cl. 382/131; 378/4; 378/8

(57) ABSTRACT

A method of reconstructing a 3D image data set of an examination zone (13) in which a substantially periodically moving object to be examined is positioned. Segments (40, 50, 60) of the examination zone (13) are reconstructed from a measuring data set acquired by the detector unit (16), said measuring data set being acquired in segments during a number n of periodically successive time intervals Δt which are smaller than the period T and succeed one another with the period T. The rotation of the radiation source (S) about the axis of rotation (14) is controlled in such a manner that during the time intervals Δt the radiation source (S) is rotated around the axis of rotation (14) through an overall angular range which is larger than or equal to a sum of 180° and an angle β, which angle β is an angle of aperture of the conical radiation beam (4) in a plane perpendicular to the axis of rotation (14). The translation of the radiation source (S) relative to the examination zone (13), in the direction of the axis of rotation (14), is controlled in such a manner that the conical radiation beam (4) completely irradiates the segment (40, 50, 60) of the examination zone (13) at all times during the n time intervals Δt.

### BACKGROUND

The present invention relates to a method of reconstructing a 3D image data set of an examination zone in which a substantially periodically moving object to be examined is positioned, which method includes the steps of:

measuring a period T of the motion of the object to be examined,

detecting a conical radiation beam, emitted by a radiation source, after its passage through the examination zone which is situated between the radiation source and a detector unit of a scanning unit,

generating, using a drive unit, a helical relative motion, taking place around an axis of rotation, between the scanning unit and the object to be examined,

reconstructing a 3D image data set of a segment of the examination zone from a measuring data set acquired by the detector unit, which measuring data set is acquired in segments during a number n of periodically successive time intervals Δt, the time intervals Δt being smaller than the period T and succeeding one another with the period T.

A method of this kind is known from EP 0 983 747 A1. The known method is employed to examine the heart of a patient. An electrocardiograph is used to record the periodic motions of the heart. The data of the electrocardiograph are used to correlate the phases of the cardiac motion of the patient to the data acquired by the detector unit. An image reconstruction unit reconstructs images of the patient on the basis of the data acquired by the electrocardiograph and the detector unit.

The use of computed tomography for imaging in the cardiac region often gives rise to images which contain artifacts due to the cardiac motion during the data acquisition. In order to reduce such artefacts, only measuring data acquired during cardiac motion phases with little motion are evaluated. The selection of the measuring data to be evaluated is performed on the basis of the electrocardiogram recorded at the same time. However, it must then be ensured that for the reconstruction an adequate amount of data is present from such cardiac motion phases with little motion of the heart, as otherwise the 3D image data set cannot be reconstructed at all.

### SUMMARY

It is an object of the invention to improve a method of the kind set forth and to enable notably an exact as possible reconstruction of the object to be examined.

This object is achieved in accordance with the invention in that the rotation of the radiation source around the axis of rotation is controlled in such a manner that during the n time intervals Δt the radiation source overall is rotated through an angular range around the axis of rotation which is larger than or equal to a sum of 180° and an angle β, the angle β representing an angle of aperture of the conical radiation beam in a plane perpendicular to the axis of rotation, the translation of the radiation source, relative to the examination zone, in the direction of the axis of rotation being controlled in such a manner that the conical radiation beam completely irradiates the segment of the examination zone at all times during the n time intervals Δt.

Thus, the detection of the periodicity of the motion of the object to be examined serves not only to realize a temporal correlation between the acquired measuring data and the phase of the motion of the object to be examined, but also to control the rotation and translation of the radiation source relative to the examination zone. The measuring data acquired during the time intervals Δt is thus correlated each time to a respective phase of the motion of the object to be examined.

For the reconstruction of a slice of the examination zone it is necessary to irradiate each point of the examination zone from an angular range of 180°. For points of the examination zone which are situated on the axis of rotation of the radiation source this condition is satisfied when the radiation source is rotated overall through 180° around the axis of rotation. For points situated at the edge of the examination zone, however, a rotation must be performed which is larger than 180°. The magnitude of the examination zone that can be reconstructed is limited by the angle of aperture β in the plane perpendicular to the axis of rotation. Only points which are situated within the radiation cone at all times can be reconstructed. The total angle of 180°+β is chosen to be such that each point of the examination zone is irradiated from all directions within an angle of 180° during the exposure. The irradiation of the points from all these directions does not take place continuously, but in segments during n successive time intervals Δt.

The afore-mentioned condition, that is, the condition that each point of the examination zone should be irradiated during the n time intervals Δt, implies that the translation of the radiation source relative to the examination zone should be suitably controlled. The radiation source moves continuously in the direction of the axis of rotation, relative to the examination zone, so that after a given period of time the conical radiation beam irradiates a segment of the examination zone which completely differs from the segment irradiated before. The measuring data set acquired during the n time intervals Δt, however, is suitable for the reconstruction of an image of the examination zone only if the acquired measuring data originates each time from the same segment of the examination zone. The translatory motion of the radiation source, therefore, must be controlled in such a manner that the conical radiation beam of the radiation source completely irradiates the segment of the examination zone at all times during the n time intervals Δt.

Preferably, during a time interval Δt the radiation source is rotated around the axis of rotation through an angular range Δλ which is larger than or equal to (180°+β)/n. When the angular ranges Δλ covered during the n time intervals Δt adjoin one another, the overall angular range covered equals n*Δλ=1 80°+β. The angular range Δλ is preferably chosen so as to be slightly larger than (180°+β)/n, so that the successive angular ranges Δλ overlap partly.

During the period T the radiation source can be rotated around the axis of rotation through an angle φ which amounts essentially to either 360°+Δλ or 360°−Δλ. During n periodically successive time intervals Δt the radiation source must be rotated through an overall angle of 180°+β around the examination zone. If the radiation source were rotated through 360° during the period T, the same angular range would be covered during each time interval Δt. The speed of rotation of the radiation source, therefore, must be chosen to be such that the n angular ranges Δλ covered during the time intervals Δt adjoin one another. This is achieved when the rotary speed is defined as described above.

The overall examination zone can be reconstructed by reconstructing 3D image data sets from a plurality of successive segments of the examination zone from the measuring data sets acquired by the detector unit, each measuring data set being acquired during a number n of measuring data-set-specific, periodically successive time intervals Δt. Each segment of the examination zone is thus reconstructed by means of the method in accordance with the invention and the overall examination zone is obtained by joining the segments. The time intervals Δt of different measuring data sets, however, may be partly identical. For example, the last n−1 time intervals for a first segment may correspond to the first n−1 time intervals for a second segment. The measuring data-set-specific time intervals Δt merely have to be chosen to be such that they enable the reconstruction of successive segments of the examination zone.

The translation in the direction of the axis of rotation is preferably controlled in such a manner that each of the segments of the examination zone is completely irradiated by a conical radiation beam during the corresponding measuring data-set-specific time intervals Δt. It is thus ensured that each of the segments can be associated with a data set which suffices for the reconstruction of an image of the segment.

The translation of the radiation source is preferably controlled in such a manner that the translation P after a rotation of the radiation source through 360° around the axis of rotation is smaller than or equal to

$$\frac{Hd}{nD ( 1 - \frac{( n - 1 ) Δ λ}{n * {360}^{∘}} )} ,$$

if the angle φ essentially corresponds to 360°−Δλ, where D corresponds to a distance between the detector unit and the radiation source, H corresponds to a height of the radiation beam in the direction of the axis of rotation at the distance D from the radiation source, and d corresponds to a constant distance between the examination zone and the radiation source.

The translation P corresponds to the distance between neighboring turns of the helix in the direction of the axis of rotation. This distance must be chosen to be such that, after n time intervals Δt have elapsed, the radiation source irradiates the same segment of the examination zone to be reconstructed. This is dependent notably on the angle of aperture of the conical radiation beam in the direction of the axis of rotation. The larger this angle, the larger a translation P can be chosen, ensuring that the same examination zone is irradiated. The height H of the radiation beam in the direction of the axis of rotation at the distance D from the radiation source, divided by the distance D, constitutes a measure of the angle of aperture in the direction of the axis of rotation.

Furthermore, the reconstructable segments of the examination zones should succeed each other without gaps. The n time intervals Δt, associated with a measuring data set, should be composed each time of the last n−1 time interval of the preceding measuring data set and the first n−1 time interval of the subsequent measuring data set. When the reconstructable segment of the examination zone has a height h in the direction of the axis of rotation, using the previously described measuring data sets a coherent region of the examination zone which is composed of the segments can be reconstructed if the time intervals Δt, or angular ranges Δλ, each time associated with the measuring data sets are shifted in space relative to one another by the height h of each segment. Finally, this distance is defined by the translatory speed for which the translation P after a rotation of the radiation source through 360° around the axis of rotation is a measure. When the translation P is chosen in conformity with the foregoing formula, the entire examination zone can be reconstructed as described above on the basis of the successive segments. When the radiation source is rotated through 360°+Δλ around the axis of rotation during the period T, for the same reasons a value smaller than or equal to

$$\frac{Hd}{nD ( 1 + \frac{( n + 1 ) Δ λ}{n * {360}^{∘}} )}$$

is to be chosen for the translation P.

In order to determine the period T, it is possible to measure the movement of the object to be examined several times and to choose a largest measuring value for the period T in the case of different measuring values for the period T. This approach is appropriate when the behavior of the object in time is not exactly periodical. The choice of an as large as possible measuring value ensures that the actual rate during the sampling of the measuring values on average is smaller than the selected period.

Preferably, the invention is used for the reconstruction of the heart. The period of the heart beat is then measured preferably by means of an electrocardiograph.

A device for carrying out the method in accordance with the invention is disclosed in claim 10. The device includes an acquisition unit, a scanning unit, a drive unit, a control unit and a reconstruction unit which are all constructed so as to be suitable for carrying out the method.

### DRAWINGS

The invention will be described in detail hereinafter with reference to the drawings.

Therein:

FIG. 1 is a diagrammatic representation of a device in accordance with the invention,

FIGS. 2a, 2b and 2c are three side elevations of a helical scanning trajectory,

FIG. 3 is a plan view of the helical scanning trajectory of the X-ray source and the examination zone,

FIGS. 4a, 4b, 4c are further side elevations of the helical scanning trajectory,

FIG. 5 is a lateral sectional view of the conical radiation beam of an X-ray source, and

FIG. 6 shows a plurality of successive cylindrical segments of the examination zone.

### DESCRIPTION

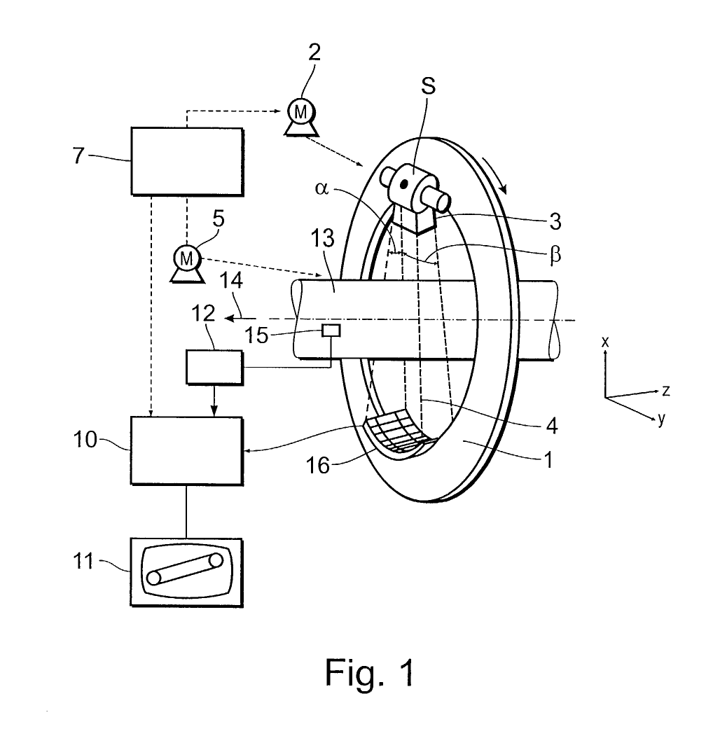

The computed tomography apparatus as shown in FIG. 1 includes a gantry 1 which is capable of rotation about an axis of rotation 14 which extends parallel to the z axis. To this end, the gantry 1 is driven by a motor 2 at a preferably constant but variable angular speed. An X-ray source S, for example, an X-ray tube is attached to the gantry 1. The radiation source is provided with a collimator device 3 which forms a conical radiation beam 4 from the radiation produced by the radiation source S. The radiation beam 4 penetrates an object to be examined (not shown) which is situated in a cylindrical examination zone 13. After having traversed the examination zone 13, the radiation beam 4 is incident on a two-dimensional detector unit 16 attached to the gantry 1. The angle of aperture of the radiation beam is denoted by the reference β (the angle of aperture is defined as the angle enclosed by the rays of the beam 4 which are situated at the edge in the x-y plane) and determines the diameter of the examination zone 13 in which the object to be examined should be present during the acquisition of the measuring values. The patient, being arranged, for example, on a patient table situated in the examination zone 13, can be displaced parallel to the direction of the axis of rotation 14 or the z axis by means of a motor 5.

The angle of aperture of the radiation beam 4 denoted by the reference α is defined by the angle enclosed by the rays of the radiation beam 4 which are situated at the edge and in the plane defined by the axis of rotation 14 and the radiation source S. The angle of aperture α determines the segment of the examination zone which is irradiated during a rotation around the axis of rotation 14.

The measuring data acquired by the detector unit 16 is applied to a reconstruction unit 10 which reconstructs therefrom the absorption distribution in the part of the examination zone 13 which is covered by the radiation cone 4 and displays this distribution, for example on a monitor 11. The two motors 2 and 5, the reconstruction unit 10, the radiation source S and the transfer of the measuring data from the detector unit 16 to the reconstruction unit 10 are controlled by an appropriate control unit 7.

The motors 2 and 5 are controlled in such a manner that the ratio of the speed of advancement of the examination zone 13 to the angular speed of the gantry 1 is constant, so that the radiation source S and the examination zone 13 move relative to one another along a helical path which is referred to as the trajectory. It is irrelevant whether the scanning unit consisting of the radiation source S and the detector 16 or the examination zone 13 performs a rotary and translatory movement, since only the relative movement is of importance.

Preferably, simultaneously with the acquisition of the measuring data a cardiac motion signal is measured by means of an electrocardiograph 12 and a sensor 15 attached to the patient. The period T of the heart beat can be determined from the electrocardiogram recorded by the electrocardiograph. The electrocardiogram is also applied to the reconstruction unit in order to perform the selection of the measuring data suitable for the reconstruction on the basis thereof. Preferably, only measuring data acquired during low-motion phases of the cardiac motion is evaluated. On the basis of the cardiac motion signal the control unit 12 controls the rotary and translatory movement of the X-ray source relative to the examination zone 13 in such a manner that the measuring data acquired during the low-motion phases of cardiac motion enable reconstruction of the examination zone 13.

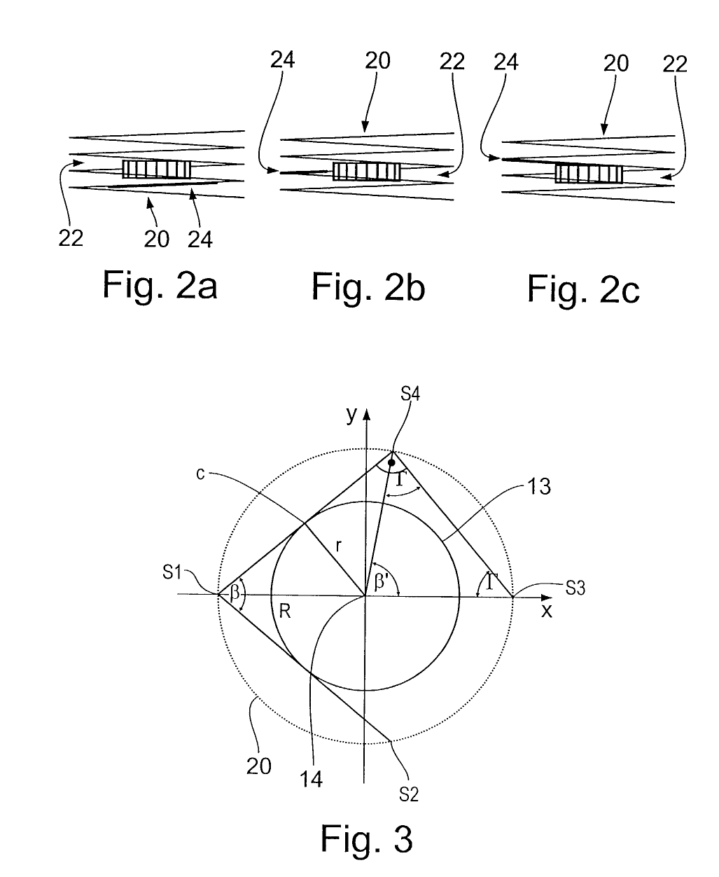

The FIGS. 2a, 2b and 2c show adjacently three views of the trajectories 20 of the radiation source S and a respective segment 22 of the examination zone 13. The segments 24 of the trajectory 20 represent the segment covered each time by the radiation source S during the time intervals Δt which succeed one another with the period T. The segment 22 of the examination zone 13 is completely irradiated by the cone-shaped radiation beam during each of the sections 24 shown, said radiation beam emanating from the radiation source S. While the radiation source S is moved along the three segments 22 of the trajectory shown, the examination zone is encircled overall through an angle of 180+β.

FIG. 3 is a plan view of the trajectory 20 and the cylindrical examination zone 13. The radius r of the examination zone 13 is defined by the angle of aperture β of the conical radiation beam emitted by the radiation source S and the distance r between the radiation source and the axis of rotation. The point s1, being the center of the co-ordinate system which is situated on the axis of rotation 14, and the point c, at which the beam s1-s4 is tangent to the examination zone 13, form a right angled triangle. Thus, for the angle β it holds that: sin(β/2)=r/R.

In order to enable reconstruction of the cross-section of the examination zone 13 shown, each point within the examination zone should be irradiated from an angular range of 180°. This holds notably for the point c shown which is situated at the periphery of the examination zone 13. To this end it is necessary to displace the radiation source S from the point s1, via the points s2, s3, to the point s4 along the trajectory 20. The radiation source S is then rotated around the axis of rotation 14 through an angle amounting to 180° plus the angle β′. In order to understand why the angle formed by the straight lines s4-14 and s3-14 corresponds to the angle of aperture β of the conical radiation beam, an auxiliary line s3-s4 is plotted. The triangle defined by the points center of the co-ordinate system, s3 and s4 is an isosceles triangle, because the points s3 and s4 are situated at a constant distance R from the co-ordinate center. The sum of the angles for this triangle amounts to β′+2γ=180°. The triangle formed by the points s1, s3 and s4 is a right-angled triangle (THALES set). The angular sum for this triangle amounts to β/2+γ=90°. It follows therefrom that β+2γ=180°. It follows from the equations β′+2γ=180° and β+2γ=180° that the two angles β′and β shown in FIG. 2 are equal.

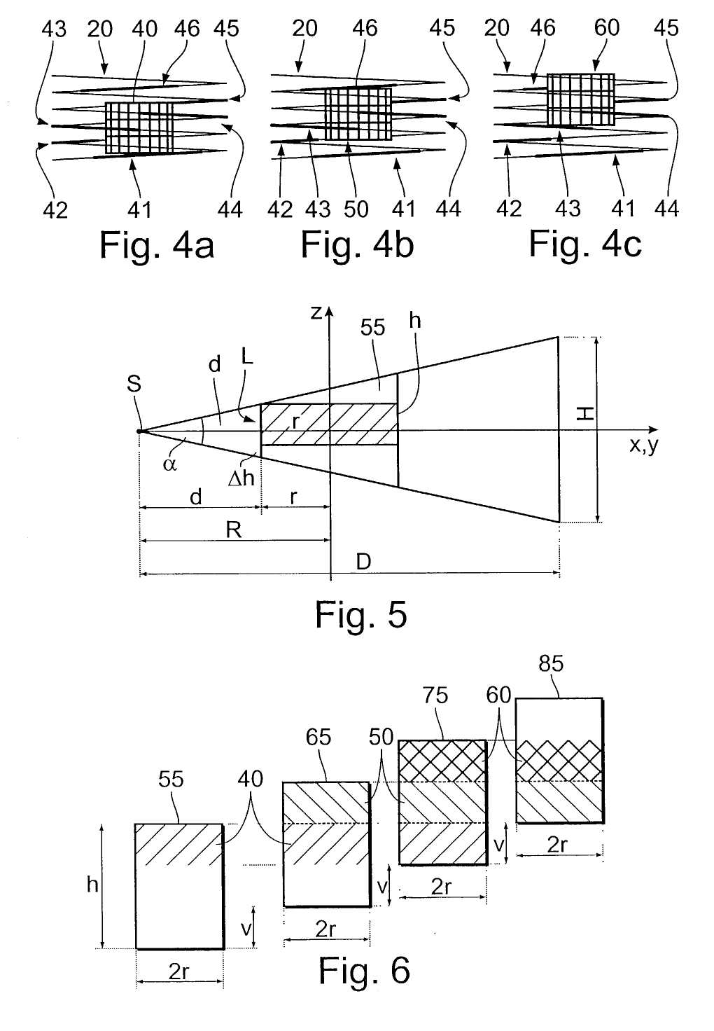

The FIGS. 4a, 4b and 4c show several views of the trajectory 20 of the radiation source S adjacent one another. The trajectory 20 encloses each time a segment 40, 50 and 60 of the examination zone. The size of the segments 40, 50 and 60 is the same, but the segments are each time offset relative to one another in the direction of the axis of rotation 14 (not shown). The trajectory 20 comprises a plurality of segments 41, 42, 43, 44, 45 and 46. The radiation source S is continuously displaced at a constant speed along the trajectory 20. The rotary speed and the translatory speed of the radiation source S are controlled in such a manner that the radiation source S covers one of the segments 41 to 46 during each one of the time intervals Δt. The time intervals Δt succeed one another with the period T of the motion of the object to be examined. Each of the time intervals Δt corresponds to an identical phase of the periodic motion of the object to be examined.

The radiation source S is displaced along one of the segments 41 to 46 each time during a time interval of the length Δt. The radiation source is then rotated around the axis of rotation 14 through an angle Δλ. During the displacement of the radiation source S along the segments 42, 43 and 44 of the trajectory, the segment 40 of the examination zone is completely irradiated; while the radiation source S is moved along the segments 43, 44 and 45, the segment 50 of the examination zone is completely irradiated. The segment 60 is completely irradiated from the segments 44, 45 and 46 of the trajectory.

The height and the position of the segments 40, 50 and 60 are dependent on the position of the corresponding segments of the trajectory as well as on the angle of aperture a of the radiation source S. The successive segments 41 to 46 are configured on the trajectory in such a manner that they can be joined without gaps by shifting these segments along the axis of rotation. The segments 41 to 46 may also overlap partly when they are linked as described above. Three linked segments of the trajectory, however, must enclose an angular range of 180°+β around the axis of rotation 14. The segment 40, 50 or 60 of the examination zone 13, corresponding to these three segments, can be reconstructed only in that case. The choice of the segments 41 to 46 in FIG. 4 is merely made by way of example. An angle of 180°+β naturally can also be enclosed by a larger or smaller number n of segments of the trajectory. The present choice of n=3 is only an example.

The reconstructable segments 40, 50 and 60 of the examination zone 13 as shown in FIGS. 4a to 4c overlap one another. The overlapping zones of the segments 40, 50 and 60 can thus be reconstructed several times. However, it is also possible to choose the trajectory and the speed of the X-ray source S on the trajectory in such a manner that the reconstructable segments 40, 50 and 60 join one another without gaps, that is, without overlap. This is shown by way of example in FIG. 6.

FIG. 5 is a lateral sectional view of the conical radiation beam (4) emitted by the radiation source S. The angle of aperture α of the conical radiation beam determines a maximum height 1 of a cylindrical segment of the examination zone which is irradiated at an arbitrary instant. During a time interval Δt the radiation source moves along the helical trajectory 20 in the direction of the z axis. During this interval the radiation source is moved in the direction of the z axis over a distance Δh. The cylindrical segment 55 of the examination zone 13 which is irradiated at the beginning and at the end of a time interval Δt is represented by shading in FIG. 5. The height h of the cylindrical segment 55 is determined as h=1−Δh. A helical path around the z axis can be described by the equation A(λ)=(R cos(λ), R sin(λ), Pλ/2π). When the radiation source S is rotated through an angle Δλ around the axis of rotation 14 or z during the time interval Δt, the shift of the height corresponds to Δh=PΔλ/2π. When the angle Δλ is expressed in degrees, it holds that Δh=PΔλ/360°. The detector unit 16 is situated at the distance D from the radiation source S. The radiation beam 4 emitted by the radiation source S has the height H at the distance D. R characterizes the distance between the radiation source S and the axis of rotation 14 and r denotes the radius of the examination zone 13. Because of the helical motion of the radiation source S, the distance D between the radiation source S and the examination zone 13 is constant during the rotation of the radiation source S around the axis of rotation 14. The height 1 of the conical radiation beam 4 at the distance D from the radiation source S thus corresponds to 1=d/DH (beam set). For the height h of the segment 40 of the examination zone 13, therefore, there is obtained h=Hd/D−PΔλ/360°.

In order to enable the reconstruction of a 3D image from the measuring data acquired during a number n of segments of the trajectory, the rays detected during the time intervals Δt must penetrate each time the same segment of the examination zone. This segment can be reconstructed only if this condition is satisfied.

FIG. 6 shows four segments 55, 65, 75 and 85 of the examination zone 13 which are irradiated during one of several successive time intervals Δt by the conical radiation beam 4 emitted by the radiation source S. The segments 55, 65, 75 and 85 each have a height h and a circular base surface of radius r. The diameter of the base surface thus amounts to 2r. The distance v in the direction of the longitudinal axis of the segments 55, 65, 75 and 85 or in the direction of the axis of rotation 14 between the segments 55, 65, 75 and 85 is chosen to be such in FIG. 6 that it corresponds exactly to ⅓ of the height h of the segments 55, 65, 75. During a time interval Δt each time one of the segments 55, 65, 75 and 85 is irradiated. The segments 55, 65 and 75 overlap one another in such a manner that they enclose the shaded segment 40. The segments 65, 75 and 85 enclose the shaded segment 50. The segment 60 is enclosed by the segments 75, 85 and a further segment which is not shown. The segments 40, 50 and 60 of the examination zone 13 of the height h/3 are completely irradiated each time during three successive time intervals Δt. During the three time intervals the radiation source is rotated through a total angle of 180°+β around the axis of rotation 14. Therefore, the segments 40, 50 and 60 can be reconstructed from the measuring data of three successive time intervals Δt.

The reconstructable segments 40, 50 and 60 are represented by respective shading in FIG. 6. The segments 40, 50 and 60 are chosen to be such that they adjoin one another without gaps. Each of the segments 40, 50 and 60 is enclosed by three of the segments 55, 65, 75 and 85. Evidently, a larger number n of segments 55, 65, 75 and 85 can also enclose a reconstructable segment. In that case it should hold that v=h/n, where n is the number of time intervals Δt or segments of the trajectory required for the reconstruction of a segment of the examination zone. In order to ensure that the segments of the trajectory enclose the examination zone 13 through an overall angle of 180°+β, the X-ray source must either be rotated through an angle of 2π−Δλ or through an angle of 2π+Δλ around the axis of rotation 13 in order to travel from a beginning of one of the segments to the beginning of the next segment. The radiation source S is then displaced over the distance v in the direction of the axis of rotation 14. For v=(2π+/−Δλ)P/360°=h/n it is possible to perform reconstruction in conformity with the proposed method. For h it also holds that h=Hd/D−PΔλ/360°. For the translation P of the X-ray source in the direction of the axis of rotation there is then obtained:

$$\frac{Hd}{nD ( 1 + \frac{( n + 1 ) Δ λ}{n * {360}^{∘}} )} or \frac{Hd}{nD ( 1 - \frac{( n - 1 ) Δ λ}{n * {360}^{∘}} )} .$$

For the reconstruction of a 3D image of the segments 40, 50 and 60 of the examination zone from the acquired image data use is preferably made of the Schaller version of a Feldkamp algorithm. Parker weighting is then applied for the reconstruction of the upper and lower sections of the segment. To this end, the segment is first transformed to the center of a co-ordinate system.

More specifically, the procedure may be as follows:

(a) Parker weighting is performed on the projections while ignoring the angles of aperture of the conical radiation beam in the direction of the axis of rotation and different positions of the radiation source relative to the axis of rotation,

(b) cosine weighting is performed for the compensation of different beam lengths,

(c) ramp filtering is performed, and

(d) backprojection of the 3D image data in the actual 3D space is performed while utilizing the helical Feldkamp algorithm. The real position of the radiation source relative to the axis of rotation is then taken into account.

1. A method of reconstructing a 3D image data set of an examination zone (13) in which a substantially periodically moving object to be examined is positioned, which method includes the steps of:
measuring a period T of the motion of the object to be examined,
detecting a conical radiation beam (4), emitted by a radiation source (S), after its passage through an examination zone (13) which is situated between the radiation source (S) and a detector unit (16) of a scanning unit,
generating, using a drive unit (2, 5), a helical relative motion, taking place around an axis of rotation (14), between the scanning unit (1) and the object to be examined,
reconstructing a 3D image data set of a segment (40, 50, 60) of the examination zone (13) from a measuring data set acquired by the detector unit (16), which measuring data set is acquired in segments during a number n of periodically successive time intervals Δt, the time intervals Δt being smaller than the period T and succeeding one another with the period T, characterized in that the rotation of the radiation source (S) around the axis of rotation (14) is controlled in such a manner that during the n time intervals Δt the radiation source (S) overall is rotated through an angular range around the axis of rotation (14) which is larger than or equal to a sum of 180° and an angle β, the angle β representing an angle of aperture of the conical radiation beam (4) in a plane perpendicular to the axis of rotation (14), the translation of the radiation source (S), relative to the examination zone (13), in the direction of the axis of rotation (14) being controlled in such a manner that the conical radiation beam (4) completely irradiates the segment (40, 50, 60) of the examination zone (13) at all times during the n time intervals Δt.

2. A method as claimed in claim 1, characterized in that during a time interval Δt the radiation source (S) is rotated through an angular range Δλ around the axis of rotation (14) which is larger than or equal to (180°+β)/n.

3. A method as claimed in claim 1, characterized in that during the period T the radiation source (S) is rotated through an angle (p around the axis of rotation (14) which essentially amounts to 360°+Δλ or 360°−Δλ.

4. A method as claimed in claim 1, characterized in that 3D image data sets of a plurality of successive segments (40, 50, 60) of the examination zone (13) is reconstructed from the measuring data sets acquired by the detector unit (16), each measuring data set being acquired during a number n of measuring data-set-specific, periodically successive time intervals Δt.

5. A method as claimed in claim 4, characterized in that the translation in the direction of the axis of rotation (14) is controlled in such a manner that each of the segments (40, 50, 60) of the examination zone (13) is completely irradiated by the conical radiation beam (4) during the corresponding measuring data-set-specific time intervals Δt.

6. A method as claimed in claim 3, characterized in that the translation of the radiation source (S) is controlled in such a manner that the translation P after a rotation of the radiation source (S) through 360° around the axis of rotation (14) is smaller than or equal to
$$\frac{Hd}{nD ( 1 - \frac{( n - 1 ) Δ λ}{n * {360}^{∘}} )}$$
if the angle φ corresponds essentially to 360°−Δλ, where D is a distance between the detector unit (16) and the radiation source (S), H is a height of the radiation beam (4) in the direction of the axis of rotation (14) at the distance D from the radiation source (S), and d corresponds to a constant distance between the examination zone (13) and the radiation source (S).

7. A method as claimed in claim 3, characterized in that the translation of the radiation source (S) is controlled in such a manner that the translation P after a rotation of the radiation source (S) through 360° about the axis of rotation (14) is smaller than or equal to
$$\frac{Hd}{nD ( 1 + \frac{( n + 1 ) Δ λ}{n * {360}^{∘}} )}$$
if the angular range φ corresponds essentially to 360°−Δλ, where D is a distance between the detector unit (16) and the radiation source (S), H is a height of the radiation beam (4) in the direction of the axis of rotation (14) at the distance D from the radiation source (S), and d corresponds to a constant distance between the examination zone (13) and the radiation source (S).

8. A method as claimed in claim 1, characterized in that the period T of the motion of the object to be examined is measured a number of times and that, in the case of different measuring volumes for the period T, a largest measuring value is chosen for the period T.

9. A method as claimed in claim 1, characterized in that the object to be examined is a heart and that the period T of the motion of the heart is measured by way of an electrocardiogram.

10. A device for reconstructing a 3D image data set of an examination zone (13) in which a substantially-periodically moving object to be examined is positioned, which device includes
an acquisition unit (12) for measuring a period T of the motion of the object to be examined,
a scanning unit (1) for detecting a conical radiation beam (4), after its passage through the examination zone (13), by means of a detector unit (16) and a radiation source (S), the radiation source (S) being arranged to emit a conical radiation beam (4) and the radiation source (S), the detector unit (16) and the examination zone (13) being positioned in such a manner that the conical radiation beam (4) traverses the examination zone (13) and is subsequently detected by the detector unit (14),
a drive unit (2, 5) for producing a helical relative motion, taking place around an axis of rotation (14), between the radiation source (S) and the objet to be examined,
a reconstruction unit (1) for reconstructing a 3D image data set of a segment (40, 50, 60) of the examination zone (13) from a measuring data set acquired by the detector unit (16), which measuring data set is acquired in segments during a number n of periodically successive time intervals Δt, the time intervals Δt being smaller than the period T and succeeding one another with the period T, and
a control unit (7) for controlling the drive unit (2, 5), characterized in that the control unit (7) is arranged to rotate the radiation source (S) around the axis of rotation (14) in such a manner that during the n time intervals Δt the radiation source (S) overall is rotated through an angular range around the axis of rotation (14) which is larger than or equal to a sum of 180° and an angle β, the angle β representing an angle of aperture of the conical radiation beam (4) in a plane perpendicular to the axis of rotation (14), and that the radiation source (S) is moved, relative to the examination zone (13), in the direction of the axis of rotation (14) in such a manner that the conical radiation beam (40) completely irradiates the segment (40, 50, 60) of the examination zone (13) at all times during the n time intervals Δt.
